(19) United States
(12) Patent Application Publication
(10) Pub. No.: US 2014/0267729 A1
(43) Pub. Date: Sep. 18, 2014

(54) ENHANCED SURVEILLANCE CAMERA

(71) Applicant: LKU TECHNOLOGY LTD., Taipei (TW)

(72) Inventor: Min-Chieh Hsu, Taipei (TW)

(73) Assignee: LKU TECHNOLOGY LTD., Taipei (TW)

(21) Appl. No.: 13/838,751

(22) Filed: Mar. 15, 2013

(51) Int. Cl. H04N 7/18

(52) U.S. Cl. CPC H04N 7/183
USPC 348/148

(57) ABSTRACT

A camera structure includes a camera, a frame defining a space to partially contain the camera, at least one plate connected to the frame to cover the camera and luminous elements securely fixed on the surface of the camera, wherein the luminous elements provide lights to the plate which is used as a billboard showing commercial messages to the public.

### BACKGROUND OF THE INVENTION

1. Field of the Invention

This invention is related to a surveillance camera having a commercial display, especially for commercials or warning massages which is displayed on the billboards configured on the outside of a camera. Moreover, lighting components are configured around the camera to provide light to the billboards to make the commercial content obvious to the public.

2. Description of the Related Art

In the present world, information is flooding everywhere and traditionally, paper is a conventional medium for delivering information, and the commercial and advertisement papers are posted and seen everywhere, such as public payphones, utility poles, public transportation stations, fire hydrants, traffic light poles . . . etc. Certainly, it influences the appearance of the city if such commercial and advertisement papers are everywhere in our daily lives. Hence, there are laws prohibiting this behavior to ensure a clean city environment.

However, using commercial flyers or posters stuck to the walls is cheap in cost and has great returns, so it is difficult to completely prevent these types of commercial and advertisement papers posted everywhere despite laws for punishing these behaviors.

### SUMMARY OF THE INVENTION

In view of related art, here is an idea for combining the commercial display with public devices, such as a surveillance camera or the like. Then, the camera has not only observation but also advertising display function.

To approach the aforementioned purpose, a camera structure is provided, which includes a camera, a frame defining a space to partially contain the camera, at least one plate connected to the frame to cover the camera, luminous elements securely fixed on the surface of the camera and providing light to the plate and a display pivotally connected to the frame, wherein the luminous elements provide light to the plate which is used as a billboard showing commercial messages or other slogans, such as “ANNIVERSARY SALE”, “ON SALE”, “NO SMOKING”, “NO TRASH”, “WELCOME”, “COME AGAIN”, “EXIT” . . . etc., the display is capable of showing other kinds of contents, such that the camera is not only providing the observation but also the advertising to the passersby around the camera.

### BRIEF DESCRIPTION OF THE DRAWINGS

The invention, as well as its many advantages, may be further understood by the following detailed description and drawings in which:

FIG. 1 is a perspective view of the surveillance camera of the first preferred embodiment of the present invention;

FIG. 2 is a perspective view of the surveillance camera of the first preferred embodiment of the present invention, wherein the plates and the camera are separated;

FIG. 3 is a perspective view of the surveillance camera of the second preferred embodiment of the present invention;

FIG. 4 is a perspective view of the surveillance camera of the third preferred embodiment of the present invention; and

FIG. 5 is a side view showing the application of the display module of the present invention.

### DETAILED DESCRIPTION OF THE INVENTION

With reference to FIG. 1 and FIG. 2, the first preferred embodiment of the present invention discloses a surveillance camera structure 1 which includes a camera 11, a first plate 12 defining therein a hole to partially receive the camera 11 therethrough and securely mounted on a periphery of the camera 11, a second plate 13 securely attached to a side face of the camera 11 and being opposite to the first plate 12, shafts 14 extended from a side face of the first plate 12 to a corresponding face of the second plate 13 and defining at least one groove in the surface of the shafts 14, two third plates 15 peripherally fitted in the grooves 141 of the shafts 14 so as to securely position the third plate 15 outside the camera 11 and provided with a medium 151 such as a piece of paper sandwiched between the third plates (or in another application, the medium 151 is attached or formed on a face of the third plate 15), first luminous elements 16 securely fixed on the outside surface of the camera 11 providing light to the third plates, a connecting element 17 securely fixed on the periphery of the first plate 12 and having a pivotable mechanism (not shown) inside the connecting element 17 and a display 18 connected to the pivotable mechanism of the connecting element 17 to be pivotally moved.

In the first embodiment of the present invention, a billboard is constructed with the aforementioned combination of the third plates 15 and the medium 151, where the medium 151 shows, for example, commercial massages, warning slogans or others, such as “ANNIVERSARY SALE”, “ON SALE”, “NO SMOKING”, “NO TRASH”, “WELCOME”, “COME AGAIN”, “EXIT” and etc. Actually, more than one billboard is able to be used, it depends on the number of the shafts 14, that is, more billboards are able to be fitted in the grooves 141 of the shafts 14 to provide multiple commercials. Moreover, the display 18 is selected from a group consisted of LCD, OLED and LED, and the display 18 shows the contents, such as “RECORDING” or “YOU ARE ON CAMERA”, to alert the personnel.

With the reference to FIG. 3, the second preferred embodiment of the present invention discloses another surveillance camera 2 which includes a camera 11, a first plate 12 defining a hole to partially receive the camera 11 therethrough and securely mounted on a periphery of the camera 11, a second plate 13 securely attached to a side face of the camera 11, shafts 14 extended from a side face of the first plate 12 to a corresponding face of the second plate 13 and defining at least one groove on the surface of the shafts 14, a connecting element 17 securely fixed on the periphery of the first plate 12 and having the pivotable mechanism (not shown) inside the connecting element 17, a display 18 connected to the pivotable mechanism of the connecting element 17 to be pivotally moved and a box 21 securely held by two of the shafts 14 and containing a luminous tube 212 inside the box 21.

In the second embodiment of the present invention, the box 21 is now used as a billboard, where a side face of the box 21 shows, for example, commercial massages, warning slogans or others, such as “ANNIVERSARY SALE”, “ON SALE”, “NO SMOKING”, “NO TRASH”, “WELCOME”, “COME AGAIN”, “EXIT” and etc. Actually, more than one billboard is able to be used to provide multiple commercials, it depends on the area size of the camera surface. Same with the first embodiment, the display 18 is selected from a group consisted of LCD, OLED and LED, and the display 18 shows the contents, such as “RECORDING” or “YOU ARE ON CAMERA”, to alert the personnel.

With reference to FIG. 4, the third preferred embodiment of the present invention discloses another surveillance camera 3 which includes a camera 11, a first plate 12 defining a hole to partially receive the camera 11 therethrough and securely mounted on a periphery of the camera 11, a connecting element 17 securely fixed on the periphery of the first plate 12 and having the pivotable mechanism (not shown) inside the connecting element 17, a display 18 connected to the pivotable mechanism of the connecting element 17 to be pivotally moved, a arcuate plate 22 formed on the surface of the camera 11 and second luminous elements 23 securely arranged within the camera 11 and providing light to the arcuate plate 22.

In the third embodiment of the present invention, the arcuate plate 22 is used as a billboard, where the surface of the arcuate plate 22 shows, for example, commercial massages, warning slogans or others, such as “ANNIVERSARY SALE”, “ON SALE”, “NO SMOKING”, “NO TRASH”, “WELCOME”, “COME AGAIN”, “EXIT” and etc. Actually, more billboards are able to be used to be hold by the shafts 14 to provide multiple commercials. Same with the first embodiment, the display 18 is selected from a group consisted of LCD, OLED and LED, and the display 18 shows the contents, such as “RECORDING” or “YOU ARE ON CAMERA”, to alert the personnel.

With reference to FIG. 5, the display 18 is able to be adjusted to a desired angle by the pivotable mechanism of the connecting element 17.

Many changes and modifications in the above described preferred embodiment of the invention can, of course, be carried out without departing from the scope thereof. Accordingly, to promote the progress in science and the useful arts, the invention is disclosed and is intended to be limited only by the scope of the appended claims.

What is claimed is:

1. A camera structure comprising:
a camera;
a frame defining a space to partially receive the camera;
at least one plate connected to the frame to cover the camera;
luminous elements securely fixed on the surface of the camera and providing light to the plate; and
a display pivotally connected to the frame.

2. The camera structure of claim 1, wherein the display is selected from a group consisted of LCD, OLED and LED.

3. The camera structure of claim 1, the plate is transparent.

4. The camera structure of claim 2, the plate is transparent.

5. A camera structure comprising:
a camera;
a frame defining a space to partially contain the camera;
at least one plate formed on the surface of the camera;
luminous elements securely arranged within the camera and providing light to the plate; and
a display pivotally connected to the frame.

6. The camera structure of claim 5, wherein the display is selected from a group consisted of LCD, OLED and LED.

7. The camera structure of claim 5, the plate is transparent.

8. The camera structure of claim 6, the plate is transparent.
